(19) United States
(12) Patent Application Publication
(10) Pub. No.: US 2025/0035917 A1
(43) Pub. Date: Jan. 30, 2025

(54) SAFETY APPARATUS AND METHOD FOR MONITORING A LIGHT PATH OF A LASER BEAM, AND APPLICATIONS OF SAME

(71) Applicant: Max-Planck-Gesellschaft zur Foerderung der Wissenschaften e. V., Muenchen (DE)

(72) Inventors: Karlheinz KAUNERT, Garching (DE); Bernd KURZAN, Garching (DE)

(21) Appl. No.: 18/690,461

(22) PCT Filed: Sep. 13, 2022
(86) PCT No.: PCT/EP2022/075416

§ 371 Date: Mar. 8, 2024

(30) Foreign Application Priority Data
Sep. 22, 2021 (DE) 10 2021 124 548.6

(51) Int. Cl. G02B 26/04; F16P 3/14; G01J 1/42

(52) U.S. Cl. CPC G02B 26/04; F16P 3/14; G01J 1/4257

(57) ABSTRACT

The invention relates to a safety apparatus (100) for monitoring a light path of a laser beam (1) and for interrupting the laser beam (1) in response to an object (2) approaching the laser beam (1), said apparatus comprising: at least one light barrier device (200) having a light source device (210) arranged to generate a safety light field (3) that extends along at least one longitudinal axis z extending in parallel with the light path of the laser beam (1), and having a sensor device (220) which has at least one sensor element (221) and which is arranged to detect the safety light field (3) and to generate a sensor signal (4) that can be varied by means of at least partial covering of the safety light field (3) by the object (2); and an interruption device (300) which is coupled to the at least one light barrier device (200) and which is arranged to interrupt the laser beam (1) according to a change in the sensor signal (4) of the at least one light barrier device (200). The invention also relates to a laser apparatus which is equipped with the safety apparatus (100), to applications of the safety apparatus (100), and to a method for monitoring a light path of a laser beam (1).

The invention relates to a safety apparatus and a method for monitoring a light path of a laser beam and for interrupting the laser beam in response to an approach of at least one object to the laser beam. The invention also relates to a laser apparatus equipped with the safety apparatus and applications of the safety apparatus. Applications of the invention are given, for example, in the operation of high-power lasers.

It is generally known that the operation of a high-power laser, e.g. for material processing or for the excitation of high-energy processes, requires measures to prevent unintended damage to objects and in particular to a user of the high-power laser. For example, during operation of the ASDEX Upgrade fusion experiment in a room adjacent to a fusion reactor, YAG lasers are operated and adjusted in order to couple infrared laser beams into the fusion reactor and determine the temperature and density of the plasma in the fusion reactor by means of Thomson scattering. YAG lasers of laser class 4, for example, have a pulsed power of around 100 MW at a wavelength of 1064 nm and a repetition frequency of 20 Hz. Persons in the room, such as technical personnel, run the risk of coming into contact with the high-energy, invisible infrared laser beam when the laser is active. Although protective goggles are mandatory in the otherwise closed-off room, the skin of the persons or another object introduced into a path of the infrared laser beam, for example, remains unprotected. The laser would, for example, cause severe burns in the event of direct skin contact and, due to the intense infrared radiation, increase the risk of skin cancer many times over. Under practical working conditions, the traffic area in the room is directly adjacent to, for example, five laser exit openings, so that there is a considerable risk of walking into an active laser or standing in the beam path of one of the lasers when it starts operating.

DE 20 2008 007 465 U1 discloses a laser light barrier having a laser light monitoring sensor with forced switch-off and switch-on, wherein the laser light barrier is operated with a modulated laser and the laser light monitoring sensor is configured to distinguish the modulated laser light from non-modulated extraneous light. If a disturbance is detected, the laser is switched off and switched on again once the disturbance has disappeared. This laser light monitoring sensor would be unsuitable for applications with high-power lasers, as it responds only when the beam path of the laser is interrupted by an object and therefore damage to the object cannot be ruled out. Furthermore, switching a high-power laser off and on would require more time than switching a light barrier, which would result in a considerable delay in the operation of the high-power laser.

DE 10 2018 104 317 A1, DE 10 2013 114 773 A1 and DE 696 33 293 T2 describe devices for laser-based energy transmission using a high-power energy transport beam. The devices are each equipped with a safety apparatus that generates a low-power laser beam parallel to the energy transport beam. When an object approaches the energy transport beam, the low-power laser beam is first interrupted, thereby generating a control signal to reduce or completely switch off the laser source of the energy transport beam. However, this power reduction of the laser source has a number of disadvantages with regard to the relatively long response time of the safety apparatus and the operating stability of the laser source. A time is typically required for the power reduction within which the object can already reach the energy transport beam and thus be damaged. Furthermore, the laser source typically requires greater control effort after the power reduction in order to return to the operating state before the power reduction. Another disadvantage is the complexity of the optical components for aligning the low-power laser beam.

The objective of the invention is to provide an improved safety apparatus and an improved method for monitoring a light path of a laser beam and for interrupting the laser beam in response to an approach of an object to the laser beam, with which disadvantages of conventional techniques are avoided. In particular, the invention is intended to minimize or exclude the risk of damage to objects, in particular persons, by a laser irradiation, to enable interrupting of the laser beam with increased reliability and/or reduced response time and/or to accelerate termination of the interrupting of the laser beam after removal of the endangered object. The objective of the invention is also to provide an improved laser apparatus which is equipped with the safety apparatus and with which disadvantages of conventional techniques are avoided.

These objectives are solved by a safety apparatus, a method and a laser apparatus comprising the features of the independent claims. Preferred embodiments and applications of the invention are shown in the dependent claims.

According to a first general aspect of the invention, the above objective is solved by a safety apparatus which is configured for monitoring a light path of a laser beam and for interrupting the laser beam in response to an approach of an object to the laser beam. The safety apparatus comprises at least one light barrier device with a light source device which is arranged for generating a safety light field which extends along a longitudinal axis which runs parallel to the light path of the laser beam, and with a sensor device which comprises at least one sensor element (sensor field) and is arranged for detecting the safety light field and generating a sensor signal which is variable by an at least partial covering of the safety light field by the object. The safety apparatus further comprises an interrupter device, which is coupled to the at least one light barrier device and is arranged for interrupting the laser beam as a function of a change in the sensor signal of the at least one light barrier device. In particular, the interrupter device is configured to shield the laser beam by mechanical means, for example a beam blocker. The change in the sensor signal may, for example, be detected by a control device that is arranged to control the interrupter device. The safety light field of the at least one light barrier device preferably extends along the entire free length of the light path of the laser beam, where it would be possible to insert an object into the light path.

According to a second general aspect of the invention, the above objective is solved by a laser apparatus which comprises a laser source device which is configured for generating a laser beam along a light path, and the safety apparatus according to the first general aspect of the invention or an embodiment thereof and which is arranged for monitoring the light path of the laser beam and for interrupting the laser beam in response to an object approaching the laser beam. Preferably, the light source device of the at least one light barrier device and the interrupter device are part of and/or fixedly coupled to the laser source device.

According to a third general aspect of the invention, the above object is solved by a method for monitoring a light path of a laser beam and for interrupting the laser beam in response to an approach of an object to the laser beam, wherein the safety apparatus according to the first general aspect of the invention or an embodiment thereof is used. The method comprises the steps of generating the at least one safety light field and detecting the at least one sensor signal, which corresponds to an undisturbed safety light field, with the at least one light barrier device, and actuating the interrupter device in the event of a change in the at least one sensor signal as a result of at least partial coverage of the at least one safety light field by the object, so that the laser beam is interrupted.

According to a fourth general aspect of the invention, the above object is solved by using the safety apparatus according to the first general aspect of the invention or an embodiment thereof for securing an operating area between at least one laser source device and a fusion reactor.

Advantageously, the invention creates a new safety system which can shield a laser beam, such as the beam of a high-power laser, in particular a YAG laser, almost instantaneously, in particular within less than 10 ms, when an object, in particular a person, approaches the laser beam. The safety light field of the at least one light barrier device is arranged in such a way that an object at least partially interrupts the safety light field before it can reach the laser beam. The safety light field creates a protective zone, the violation of which triggers the interruption of the laser beam. The light source device generates the safety light field in the visible or infrared spectral range with a power that is not critical for the object.

The invention allows maximum flexibility and safety when working with high-energy lasers in all areas of application. Damage to the object interrupting the safety light field is excluded. The inventor has found that the safety light field can be dimensioned in such a way that the laser beam to be shielded is interrupted quickly enough to prevent damage to the object, even if the object is moving. The interrupting of the laser beam takes place with increased reliability, as the safety apparatus forms a light barrier with a switching effect for the laser beam. The interrupting of the laser beam after removal of the endangered object can be accelerated, as the laser beam does not necessarily have to be switched off, but can be shielded by mechanical means.

According to a preferred embodiment of the invention, the light source device is configured for generating the safety light field in the shape of a beam tube which extends along the longitudinal axis and radially surrounds the exposed light path of the laser beam at least on half-side, particularly preferably on all sides. The safety light field forms the beam tube in such a way that the light path of the safety light field extends exclusively along the surface (or a surface layer) of the beam tube or that the safety light field fills the entire volume of the beam tube. Advantageously, the beam tube provides a protective zone enveloping the laser beam in at least a half-space. The orientation of the half-space can be selected depending on the specific application conditions. A beam tube that surrounds the laser beam radially on all sides has the advantage that it can be used to detect an approach from any radial direction.

Particularly preferred, the beam tube is in the shape of a straight circular cylinder or a cone shape. Both shapes have a circular cross-section, resulting in advantages in terms of beam shaping with available optics. In the case of a circular cylinder, the safety light field is aligned parallel to the laser beam. The cone shape means that the safety light field is shaped divergently, e.g. starting from the light source device and tapering or widening. With the cone shape, the safety light field can be adapted to an optionally provided divergent shape of the laser beam, for example. Alternatively, the beam tube can have a different shape, e.g. with an ellipsoidal cross-section or even with a cross-section approximating a rectangle.

As an alternative to the shape of the half-sided to complete beam tube, the safety light field can comprise a cross-sectional shape that extends radially in relation to the light path of the laser beam over at least one angular section of less than 180° up to a few degrees, e.g. 5°. The safety light field can be shaped on one or more sides along the light path, e.g. in such a way that it covers several radial angular sections of equal or different angular amounts. Advantageously, the safety light field can thus be adapted to specific application conditions and, for example, limited to certain areas of the room in which an object or several objects can approach the laser beam.

The light source device may comprise an adjustable focus or a fixed focus. Preferably, the light source device comprises a single light source with a divergent beam field and a beam shaping device which is configured to shape the safety light field from the divergent beam field. The use of a single light source has the advantage that a defect or any power fluctuations of the light source affect the entire safety light field. A change in the sensor signal due to a power fluctuation of the light source can be detected more easily and distinguished from an introduction of an object into the safety light field.

When using the single light source, a configuration is particularly preferred in which the beam shaping device comprises a mirror arrangement with a deflection mirror and a collimation mirror and the light source is arranged radially spaced from the longitudinal axis, wherein the deflection mirror is arranged for deflecting the divergent beam field of the light source towards the longitudinal axis and the collimation mirror is arranged for shaping the safety light field to be parallel or divergent relative to the longitudinal axis. The deflection mirror is, for example, a plane mirror with a mirror surface with a shape of a circular or elliptical ring. An opening is provided in the center of the deflection mirror through which the laser beam passes.

Alternatively, the light source device may comprise a plurality of light sources arranged for shaping the safety light field. This embodiment may have advantages for shaping the safety light field, for example by omitting a beam shaping device or using a beam shaping device with a simplified structure. If multiple light sources are provided, the sensor device preferably is equipped with one sensor element per light source, wherein the sensor elements particularly preferably are connected in series. Due to the series connection, a defect or a power fluctuation of at least one of the light sources would cause the interrupter device to be actuated, so that the defect or the power fluctuation can be easily detected.

According to further variants of the invention, the light source device may comprise at least one light source and a plurality of optical fibers. The optical fibers are each coupled at a first end to the at least one light source. In each case opposite, second ends of the optical fibers are directed onto a fiber collimator for shaping the safety light field and are arranged in a circle. The fiber collimator is used to align divergent beams at the exit point of each individual optical fiber in parallel.

For example, one single light source can be coupled to all optical fibers, or single optical fibers or groups of optical fibers can each be coupled to one light source from multiple light sources. The combination of the at least one light source and with the optical fibers has the advantage that the at least one light source can be arranged at a distance from the safety apparatus, e.g. in a separate room. The position of the at least one light source is not bound to an optical axis. One single light source can be provided for multiple safety apparatuses.

The at least one light source of the light source device is preferably a laser with an emission in the visible spectral range (so-called protective laser). Lasers have advantages due to the directional, parallel or divergent radiation of the emission and their high power. Alternatively, the at least one light source can comprise a light-emitting diode.

According to a preferred embodiment of the invention, the sensor device comprises a light-sensitive sensor area which is adapted to a cross-sectional shape of the safety light field. Advantageously, this minimizes the detection of interfering extraneous light and increases the reliability of the interrupting of the laser beam in response to an approach of an object to the laser beam. The light-sensitive sensor area of the sensor device is particularly preferably in a form of a half circular ring, preferably a complete circular ring.

Further advantages of the invention result from the large number of available light-sensitive elements that form the at least one sensor element of the sensor device. According to a first variant, the at least one sensor element may comprise a photoresistor. The use of a photoresistor has advantages in terms of cost, processing of the output signal and adaptation of the sensor area to the cross-sectional shape of the safety light field. According to a second variant, the at least one sensor element can comprise a photodiode. In this case, there may be advantages with regard to the sensitivity of the detection of the safety light field.

According to a further variant of the invention, the at least one sensor element may be provided with a beam collector which is configured for collecting the safety light field at the at least one sensor element. The beam collector is an optical, preferably reflective component which directs parts of the safety light field, particularly preferably all partial beams of the surface or surface layer of said beam tube, onto the sensor area of the sensor device.

According to a further advantageous embodiment of the invention, it is provided that the sensor device comprises a plurality of sensor elements connected in series. This enables the sensor device to provide one single sensor signal, which simplifies the evaluation of the output of the sensor device.

Further advantages in terms of avoiding the detection of extraneous light and the increased reliability of the safety apparatus are achieved if the sensor device, in accordance with a further variant of the invention, comprises a stray light shield which extends along the longitudinal axis at one end section of the safety light field on the sensor device and is configured for shielding the safety light field from ambient light. The stray light shield has, for example, the shape of a hollow cylinder or hollow cone with an axis parallel to the light path of the laser beam or of two nested hollow cylinders or hollow cones which enclose the safety light field in their end section.

According to a preferred embodiment of the invention, the interrupter device comprises a beam blocker and a drive device which is coupled to the sensor device, wherein the beam blocker is movable, in particular pivotable, with the drive device into or out of the light path of the laser beam dependent on the sensor signal from the sensor device. The beam blocker is a solid object that preferably scatters the laser beam in space (volume scatterer). The beam blocker can be moved between a condition in which it unblocks the light path of the laser beam and a condition in which it interrupts the light path of the laser beam. Advantageously, the mechanically operated beam blocker enables rapid interrupting and releasing of the laser beam without having to switch off the laser source device for generating the laser beam. In particular, a termination of interrupting of the laser beam can be accelerated after removal of the endangered object, so that undesirable delays in the operation of the laser source device are avoided.

Advantageously, a large number of design variants of the beam blocker are available, which can be selected depending on the specific application conditions and in particular the wavelength of the laser beam. According to a first variant, the beam blocker can be made of a synthetic foam material. Foams are advantageously light and therefore easy to pivot into the light path of the laser beam. Furthermore, foams can easily scatter the field of the laser beam in space.

Alternatively or additionally, the beam blocker can be made of a clear, non-absorbent translucent plastic, such as PET foam (polyethylene terephthalate foam), which is advantageous for the application of the invention for interrupting a laser beam with a wavelength in the infrared range.

According to a further variant, the beam blocker can be made of PTFE, in particular PTFE foam or PTFE solid material. PTFE has advantages in terms of the durability of the beam blocker, as PTFE has a temperature resistance up to about 380° C.

Preferably, the beam blocker has the shape of a hollow cylinder which is pivotable about a transverse axis perpendicular to the longitudinal axis such that the beam blocker releases the light path of the laser beam in a non-pivoted state and blocks the light path of the laser beam in a pivoted state. In the non-pivoted state, the beam blocker is arranged so that the laser beam passes freely through the hollow cylinder. In the pivoted state, the axis of the hollow cylinder is rotated in relation to the longitudinal axis of the laser beam so that the material of the hollow cylinder is hit by the laser beam. The hollow cylinder shape advantageously increases the speed of interrupting and releasing the laser beam, as when the hollow cylinder is rotated, its material is introduced radially into the laser beam from two sides.

Alternatively, the beam blocker can be arranged separately from the safety apparatus in the laser source device for generating the laser beam. The beam blocker can, for example, comprise a shutter contained in the laser source device. This variant would have advantages due to the compact integration of the beam blocker into the laser source device.

According to a modified variant, an iris aperture can be provided as a beam blocker, which can be set between an open state and a closed state using the drive device depending on the sensor signal from the sensor device. The iris aperture can have advantages due to its small space requirement. According to a further variant, a metal plate with a scattering surface, e.g. a sandblasted metal plate, can be provided as a beam blocker.

According to a further preferred feature of the invention, the at least one light barrier device and the interrupter device comprise axially extending passage openings which leave the light path of the laser beam free. This embodiment of the invention has particular advantages for a compact design of the safety apparatus.

According to a preferred embodiment of the invention, the light source device and the sensor device of the safety apparatus can be arranged at a mutual distance which encloses the space to be protected in which an object could be introduced into the laser beam. The light path of the safety light field extends in one single directional sense from the light source device to the remote sensor device. For example, one of the light source device and the sensor device can be arranged directly adjacent to the interrupter device and the laser source device or directly adjacent to a space for applying the laser beam, e.g. a fusion reactor or another irradiation site.

Alternatively, the light source device and the sensor device can be arranged adjacent to each other. In this case, a ring mirror is provided with which the light path of the safety light field is folded, and the light source device and the sensor device on the one hand and the ring mirror on the other hand are arranged at a mutual distance which encloses the space to be protected in which an object could be introduced into the laser beam. Accordingly, according to this embodiment of the invention, the light source device, the ring mirror and the sensor device are arranged such that the safety light field extends from the light source device via the ring mirror to the sensor device. The embodiment using the ring mirror has advantages if electromagnetic fields occur at the end of the monitored light path of the laser beam, e.g. due to physical processes at the irradiation site, which could interfere with the operation of the sensor device or the transmission of the sensor signal. This is the case, for example, with fusion systems with magnetic plasma confinement.

The ring mirror is generally a flat mirror or, if required, a curved mirror for beam shaping purposes with a central opening through which the laser beam passes, e.g. a circular ring mirror. The light source device and the sensor device can be installed in a common unit. The light path of the safety light field runs in alternating sense of directions from the light source device to the distant ring mirror and from this to the sensor device near or immediately adjacent to the light source device.

According to a further variant of the invention, the light source device is configured for a modulated operation such that a modulation is applied to the safety light field, and the sensor device is coupled to an evaluation device which is configured for detecting the modulation of the safety light field and for generating the sensor signal only if the modulation of the safety light field is detected. The evaluation device is contained, for example, in a computer circuit coupled to the sensor device or in the control device for activating the interrupter device. Advantageously, this creates an intelligent light barrier whose sensor only responds to modulated light. If several laser beams are monitored, a specific modulation could be generated with each light source device, which can only be detected by the associated sensor device. In this way, the light from a neighboring light source device could also be detected as ambient light by a sensor device.

Advantageously, the safety apparatus according to a preferred embodiment of the invention may be provided with one single light source device, wherein the light source device and the sensor device are arranged at the ends of a light path of the laser beam to be monitored. In this embodiment, one single light source device and one single sensor device are provided, whereby the safety apparatus advantageously has a small space requirement. Particularly preferably, the light path to be monitored extends through the entire free space from the laser source device for generating the laser beam to an application site of the laser beam, such as an irradiation site or, according to the preferred application of the invention, to the fusion reactor.

According to an alternative embodiment of the invention, the safety apparatus can be provided with at least two light barrier devices which are arranged consecutively to one another on the light path of the laser beam to be monitored, wherein the light source device and the sensor device of each of the at least two light barrier devices are arranged at the ends of a respective section of the safety light field of the light path of the laser beam to be monitored, wherein the interrupter device is coupled to each light barrier device and is arranged for interrupting the laser beam dependent on a change in the sensor signal of at least one of the light barrier devices. This embodiment offers advantages if particularly long light paths are to be monitored. The subdivision into shorter sections, each with a light barrier device, simplifies the adjustment of the light barrier devices, reduces the vibration sensitivity of the light barrier devices, reduces the effects of any divergence of the safety light field and improves the reliability of the monitoring of the light path.

Particularly preferably, all sections of the light path to be monitored extend in series through the entire free space from the laser source device for generating the laser beam to the place of application of the laser beam, such as the irradiation site or the fusion reactor. In the embodiment with two or more light barrier devices, these are preferably arranged directly adjacent to one another, so that the sensor device of the second or each additional light barrier device is positioned directly next to the light source device of the respective preceding light barrier device along the light path of the laser beam to be monitored or is even permanently connected to it. Alternatively, a distance can be provided between at least two of the light barrier devices, in which, for example, a radial shielding of the laser beam is present or an optical device, such as beam diagnostics, is arranged.

Both in the embodiment with one single light barrier device and in the embodiment with two or more light barrier devices, the light path to be monitored can be configured to be continuously straight or angled with at least one mirror. In the variant with an angled light path, it can be advantageous to provide straight sections of the angled light path as sections of the light path with light barrier devices. Furthermore, the safety apparatus can also be configured with at least two light barrier devices with a folded light path of at least one of the light barrier devices.

The features disclosed in connection with the safety apparatus and embodiments thereof also represent preferred features of the method according to the invention and the laser apparatus according to the invention and vice versa. The above-mentioned aspects and inventive and preferred features, in particular with regard to the structure of the safety apparatus and the dimensions and compositions of the individual components described in connection with the safety apparatus, therefore also apply to the method. The preferred embodiments, variants and features of the invention described above can be combined with one another.

Further details and advantages of the invention are described below with reference to the accompanying drawings. These show schematically:

FIG. 1: a sectional view of a first embodiment of the safety apparatus according to the invention with an undisturbed safety light field;

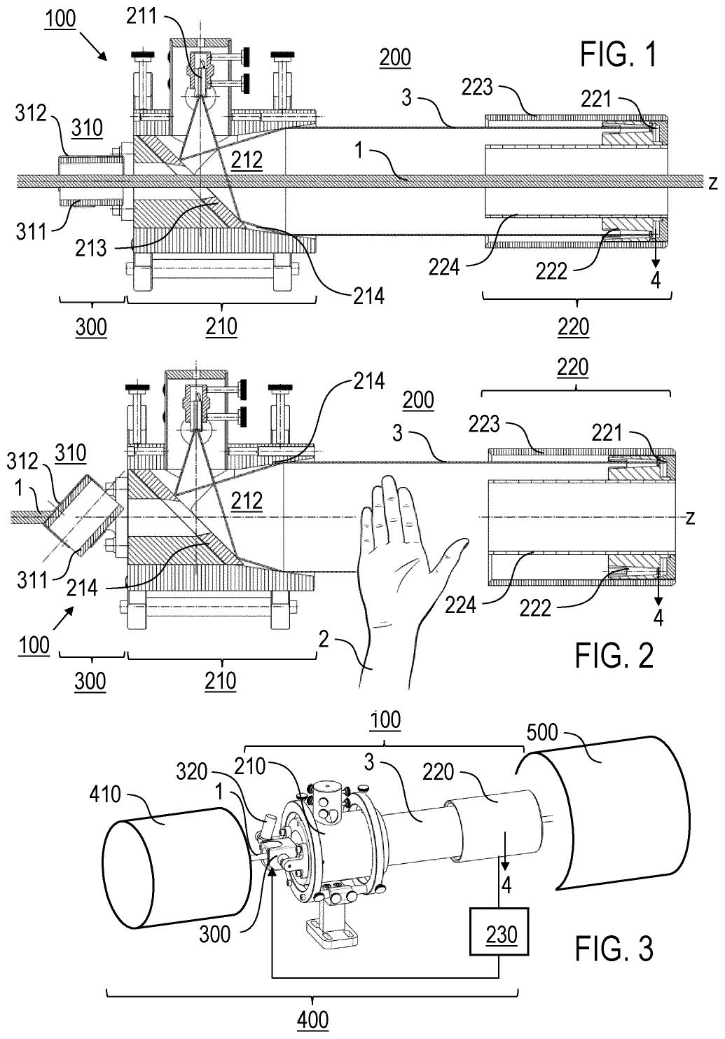

FIG. 2: a sectional view of the first embodiment of the safety apparatus according to FIG. 1 with an interrupted safety light field;

FIG. 3: a perspective view of an embodiment of the laser apparatus according to the invention with a safety apparatus as shown in FIG. 1;

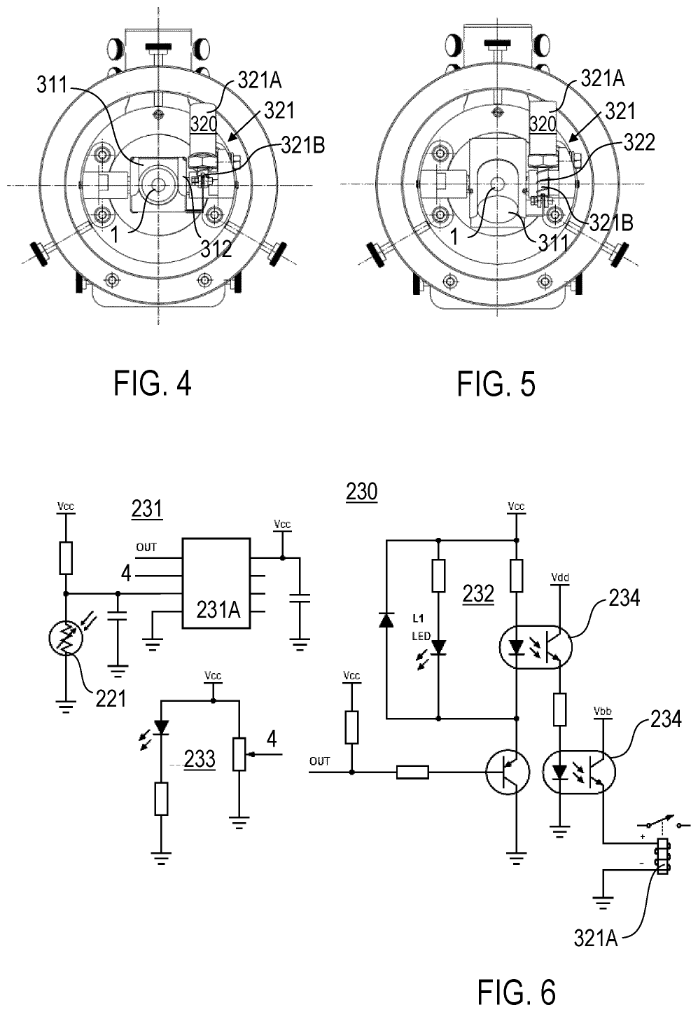

FIGS. 4 and 5: top views of the interrupter device of the safety apparatus according to FIG. 1 in the open and blocked state;

FIG. 6: a circuit diagram of a control device for controlling the interrupter device;

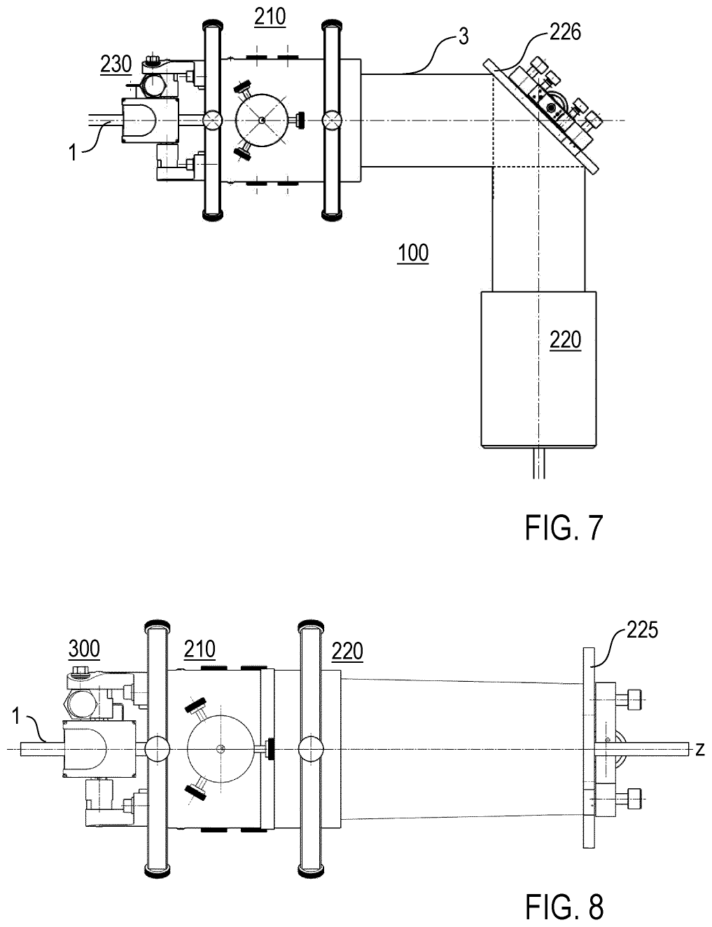

FIG. 7 a sectional view of a second embodiment of the safety apparatus according to the invention with an angled light path of the monitored laser beam;

FIG. 8 a sectional view of a third embodiment of the safety apparatus according to the invention with a folded safety light field; and

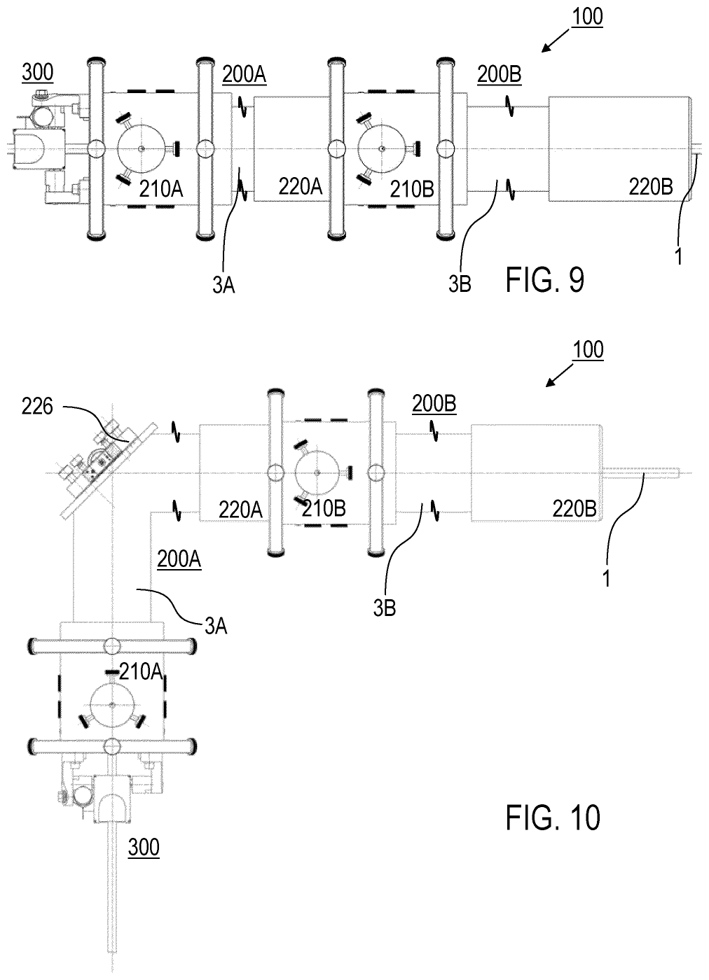

FIGS. 9 and 10: embodiments of the safety apparatus according to the invention with multiple light barrier devices.

Embodiments of the invention are described below with exemplary reference to an application of the invention for monitoring high-power infrared lasers which are operated for measurement purposes at a fusion reactor, such e. g., the ASDEX Up-grade fusion experiment. The invention is not limited to this application, but can be implemented accordingly for monitoring other lasers. Details of the laser apparatus for generating the monitored laser beam are not described, as these are known per se from conventional lasers, such as YAG or CO₂ lasers. Deviating from the illustrations, the light source device can comprise a combination of one or more light source(s) and a plurality of optical fibres with a fibre collimator to form the safety light field.

It is emphasized that the drawings are schematic illustrations. In practical application, other dimensional ratios, in particular longer lengths of the monitored light path of the laser beam, such as e. g. up to 20 m or more, are generally realized.

FIGS. 1 and 2 show a first embodiment of the safety apparatus 100 with a light barrier device 200 and an interrupter device 300. The safety apparatus 100 is provided for monitoring the light path of the laser beam 1, which extends in a straight spatial direction (z-direction). FIG. 3 illustrates a laser apparatus 400 equipped with a laser source device 410 and the safety apparatus 100. The laser beam 1 is generated by the laser source device 410, which is not shown in FIGS. 1 and 2. FIG. 3 illustrates a main application of the invention in which the laser source device 410 comprises a YAG laser, e.g. with an output energy of 3 joules, whose laser beam 1 is coupled into a fusion reactor 500, e.g. for diagnostic purposes.

The light barrier device 200 of the safety apparatus 100 according to FIGS. 1 and 2 comprises a light source device 210 and a sensor device 220, which in the first embodiment of the invention are arranged at a mutual distance at the ends of the monitored light path of the laser beam 1. The light source device 210 is used to generate a safety light field 3 which extends along a longitudinal axis (z-direction) which runs parallel to the light path of the laser beam 1 and envelops the laser beam 1 on all sides.

The light source device 210 comprises one single light source 211, such as a laser or in particular a laser diode with an emission in the visible spectral range (e.g. laser diode of the type DOE219-635-5-6 (-ADJ) (manufacturer Picotronic GmbH) with an opening angle (divergence) of 34°, an emission wavelength of 640 nm and a power of 5 mW). The light source 211 is arranged radially at a distance from the z-direction of the light path of the laser beam 1. The distance is selected as a function of the divergence of the light source 211 and is, for example, 7 cm at the opening angle of 34°. The light source 211 has a predetermined divergence due to its structure. The divergent beam field of the light source 211 is converted into the safety light field 3 using a beam shaping device 212. Alternatively or additionally to beam shaping with the beam shaping device 212 with mirrors, focusing of the beam field of the light source 211 with lens optics would be possible.

The beam shaping device 212 comprises a mirror arrangement with a deflection mirror 213 and a collimation mirror 214. The mirror arrangement is provided on a fully adjustable mirror holder. The deflection mirror 213 is, for example, a ring mirror with a central opening through which the laser beam 1 passes. The deflection mirror 213, which is inclined relative to the z-direction, e.g. by 45°, is used to deflect the beam field of the light source 211 toward the z-direction. The deflection mirror 213 is, for example, a plane, polished Al-mirror with an SiO₂ cover layer.

The collimating mirror 214 has a hollow cone surface. It acts as a parallel rectifier that converts the beam field of the light source 211 into the beam tube cylindrical shape of the safety light field 3. The geometric shape of the collimating mirror 214 is selected depending on the opening angle of the light source 211. In particular, the collimating mirror 214 can be slightly concave in order to compensate for the divergence of the light source 211 or to introduce a predetermined divergence into the safety light field 3. Alternatively or additionally, at least one adjustable lens (not shown) can be provided between the light source 211 and the collimating mirror 214 in order to adjust the divergence in the safety light field 3. By adjusting the divergence, the safety light field 3 could be optimized in particular as a function of the distance between the light source device 210 and the sensor device 220.

The safety light field 3 extends from the collimation mirror 214, enveloping the laser beam 1, to the sensor device 220. The diameter of the safety light field 3 is, for example, 90 mm, while the diameter of the laser beam is, for example, 10 mm.

The sensor device 220 has a tubular shape, the axis of which coincides with the light path of the laser beam 1 and the longitudinal axis of the safety light field 3. Accordingly, the sensor device 220 has an axially extending, central hollow space through which the laser beam 1 passes. The sensor device 220 comprises at least one sensor element 221 with a light-sensitive sensor area, the shape of which is adapted to the shape of the safety light field 3 and accordingly comprises, for example, a ring-shaped photoresistor or multiple photoresistors arranged with a ring-shape. If multiple, e.g. 10 to 20, photoresistors are provided as sensor elements 221 to form the light-sensitive sensor area, the photoresistors are preferably connected in series so that they output one single sensor signal 4 (see FIG. 3), which is variable when the safety light field 3 is interrupted. Alternatively, the photoresistors can each emit a signal from which the sensor signal of the sensor device 220 is selected or generated.

A beam collector 222, which comprises a reflector, e.g. made of aluminium, is provided on the irradiation side in front of the light-sensitive sensor area. The beam collector 222 is shaped such that the safety light field 3 is directed as completely as possible to the light-sensitive sensor area of the sensor element 221.

Furthermore, in order to protect the light-sensitive sensor area of the sensor element 221 from stray light, the sensor device 220 is provided with a hollow cylindrical outer stray light shield 223. With an axial length of e.g. 150 mm, the stray light shield 223 forms the tubular shape of the sensor device 220 and is made of e.g. aluminium. Preferably, an inner stray light shield 224 is also provided, which runs coaxially to the outer stray light shield 223 and to the z-axis.

The interrupter device 300 is coupled to the light barrier device 200, in particular mechanically to the light source device 210 and electrically to the sensor device 220, and is arranged for interrupting the laser beam 1 as a function of a change in the sensor signal 4 of the sensor device 220. The interrupter device 300 comprises a beam blocker 310 and a drive device 320 (not shown in FIGS. 1 and 2, see FIGS. 3, 4 and 5), which is coupled to the sensor device 220 via a control device 230 (not shown in FIGS. 1 and 2, see FIGS. 3 and 6).

The beam blocker 310, shown with further details in FIGS. 4 and 5 (top views on a plane perpendicular to the z-axis from the side of the laser source device 410), comprises a PTFE foam member 311 having a central bore. The foam member 311 is seated in a sleeve-shaped housing 312, which is coupled to a rotatably supported lifting magnet 321 of the drive device 320.

The lifting magnet 321 comprises a cylindrical coil 321A and a ferromagnetic pin 321B. By activating the cylindrical coil 321A, the lifting magnet 321 can be moved between two positions (see FIGS. 4 and 5). In an electrically energized state of the cylindrical coil 321A, the lifting magnet 321 is arranged in the first position such that the central bore of the foam member 311 is aligned with the z-axis and the laser beam 1 passes freely through the foam member 311 (FIG. 4). In the de-energized state of the cylindrical coil 321A, the lifting magnet 321 is arranged in the second position such that the central bore of the foam member 311 is rotated relative to the z-axis and the laser beam 1 strikes the foam member 311 and is blocked (FIG. 5).

FIG. 1 shows the normal state of the safety apparatus 100, in which the safety light field 3 generated by the light source 211 irradiates the sensor device 220 undisturbed. The sensor signal 4 of the sensor device 220 causes the cylinder coil 321A of the drive device 320 to be activated and the foam member 311 in the first position of the lifting magnet 321 to release the laser beam 1. If an object 2, such as a user's hand, comes into the safety light field 3 (see FIG. 2), the safety light field 3 is partially covered. This changes the sensor signal 4 of the sensor device 220, as described with further details below with reference to FIG. 6. The control device 230 is used to switch the cylinder coil 321A to the de-energized state, so that the lifting magnet 321 is released and the housing 312 with the foam member 311 is rotated to the second position under the effect of gravity and/or a return spring 322 (see FIG. 5) and blocks the laser beam 1.

Practical tests have shown that interrupting the laser beam is possible in a time interval <25 ms or even <10 ms, whereby the laser beam 1 is blocked before the object 2 reaches the laser beam 1 in the centre of the safety light field 3, even if the object 2 is moving at speeds typically occurring in the operating space of the laser apparatus 400.

FIG. 6 shows details of the control device 230, which is configured to control the interrupter device 300 as a function of the control signal 4 from the sensor device 220 (see FIG. 3). The control device 230 comprises an input circuit 231 for receiving and evaluating the sensor signal 4 of the sensor element 221 and a driver circuit 232 for actuating the interrupter device 300. Furthermore, an optional display circuit 233 is provided, which is actuated by the sensor signal 4 and by means of which the operating state of the control device 230 is signalled by an LED. The control device 230 can be provided by a commercially available, integrated and programmable circuit.

The input circuit 231 contains a comparator circuit 231A, e.g. of type Lm393, which receives the sensor signal 4 of the sensor element 221 at its input as an input variable and generates an output signal OUT by comparison with stored reference variables, which is linked by the driver circuit 232 with the interrupter device 300. If the safety light field 3 is at least partially covered, the sensor signal 4 changes so that the comparison with the reference variable provides a modified result. The output signal OUT of the comparator circuit 231A accordingly has two states (levels), which represent the undisturbed state or the covered state of the safety light field 3.

The driver circuit 232 converts the output signal OUT with the level of the undisturbed state into the generation of a driver voltage, e.g. 24 V, to activate the cylindrical coil 321A. As a result, the laser beam 1 is released (FIGS. 1, 4). If the output signal OUT of the input circuit 231 has the level of the covered state, the drive voltage is set to zero, so that the cylindrical coil 321A enters the de-energized state and the laser beam 1 is interrupted (FIGS. 2, 5). For this purpose, the driver circuit 232 contains several amplifier stages, which are preferably realised by optical relays 234, which introduce a galvanic isolation between the sensor device 220 and the interrupter device 300.

FIG. 7 shows a second embodiment of the invention, in which the safety apparatus 100 with the light source device 210, the sensor device 220 and the interrupter device 300 is substantially constructed as in FIGS. 1 and 2. Deviating from the first embodiment, the light path of the laser beam 1 is angled, for example by 90°, by a plane additional deflection mirror 226. The additional deflection mirror 226 is simultaneously arranged for a schematically shown deflection of the safety light field 3, so that the safety light field 3 envelops the laser beam 1 on all sides along the entire monitored length of its light path.

FIG. 8 shows a third embodiment of the invention, in which the light source device 210 and the sensor device 220 are arranged adjacent to each other as a unit. In order to form the safety light field 3 along the light path of the laser beam 1, a ring mirror 225 is provided which reflects the safety light field 3 generated by the light source device 210 so that it can be received by the sensor device 220. In this embodiment, the safety light field 3 has a divergent shape with a widening diameter in order to direct the safety light field 3 first through the central opening of the sensor device 220 to the ring mirror 225 and from this to the light-sensitive surface outside the central opening of the sensor device 220.

Deviating from FIG. 8, the ring mirror 225 can be arranged at the interrupter device 300 and the combination of the light source device 210 and the sensor device 220 can be arranged at a distance from the interrupter device 300.

In the embodiments of FIGS. 7 and 8, the interrupter device 300 is actuated as described above with reference to FIGS. 1 to 6.

As illustrated in FIGS. 9 and 10, the safety apparatus 100 can comprise two or more successively arranged light barrier devices 200A, 200B, each with a light source device 210A, 210B and with a sensor device 220A, 220B for generating and detecting the safety light field in sections 3A, 3B along the light path of the laser beam 1, in particular in the case of a particularly long light path and/or a light path angled via at least one additional deflection mirror 226. For reasons of clarity, only two light barrier devices 200A, 200B and the respective light source and sensor devices in sections 3A, 3B are not shown in their entirety, but with a small distance between them. In practice, more light barrier devices may be provided, with the light source and sensor devices in the respective sections 3A, 3B of the light path of the laser beam 1 having larger distances, depending on the spatial conditions.

Each of the light barrier devices 200A, 200B is constructed as described above. Each of the sensor devices 220A, 220B is coupled to the interrupter device 300 which, also as described above, interrupts the laser beam 1 when the safety light field is violated depending on a change in the sensor signal 4 from at least one of the sensor devices 220A, 220B. The light source device 210B of the light barrier device 200B preferably forms a unit with the sensor device 220A of the light barrier device 200A.

According to further modified embodiments of the invention, the safety apparatus 100 can be realized with at least one of the following features.

The light source 211 can comprise a variable or a fixed focus. With the variable focus, the diameter of the safety light field 3 can be varied. The fixed focus can have advantages for a compact design of the light source device 210.

The diameter of the safety light field 3 can alternatively or additionally be adjusted, in particular enlarged, using imaging, reflective optics.

In deviation from the illustrations, the radiation direction of the light source 211 can be provided parallel to the z-axis, i.e. parallel to the laser beam 1, in which case the beam shaping device 212 is adapted to form the safety light field 3. Instead of the single light source 211, several light sources, e.g. 10 or more lasers, can be arranged on a circular ring surface and generate the safety light field 3 directly, i.e. without a beam shaping device.

The generation of an audio signal can be provided for signalling an interrupting of the laser beam 1. The audio signal can, for example, be generated by the control device 230 and serve as a warning when the laser is active and when the safety laser zone is violated.

The features of the invention disclosed in the above description, the drawings and the claims may be of importance for the realisation of the invention in its various embodiments, both individually and in combination or sub-combination.

### LIST OF REFERENCE NUMERALS

1 laser beam
2 object
3 safety light field
3A section of the safety light field
3B section of the safety light field
4 sensor signal
100 safety apparatus
200 light barrier device
200A light barrier device
200B light barrier device
210 light source device
210A light source device
210B light source device
211 light source
212 beam shaping device
213 deflection mirror
214 collimation mirror
220 sensor device
220A sensor device
220B sensor device
221 sensor element
222 beam collector
223 outer stray light shield
224 inner stray light shield
225 ring mirror
226 additional deflection mirror
230 control device
231 input circuit
231A comparator circuit
232 driver circuit
233 display circuit
234 optical relays
300 interrupter device
310 beam blocker
311 foam member
312 housing
320 drive device
321 lifting magnet
321A cylindrical coil
321B ferromagnetic pin
322 return spring
400 laser apparatus
410 laser source device
500 fusion reactor

1-23. (canceled)

24. A safety apparatus configured for monitoring a light path of a laser beam and for interrupting the laser beam in response to an approach of an object to the laser beam, comprising:
at least one light barrier device with a light source device which is arranged for generating a safety light field which extends along at least one longitudinal axis which runs parallel to the light path of the laser beam and with a sensor device which comprises at least one sensor element and is arranged for detecting the safety light field and generating a sensor signal which is variable by an at least partial covering of the safety light field by the object, and
an interrupter device which is coupled to the at least one light barrier device and is arranged for interrupting the laser beam as a function of a change in the sensor signal of the at least one light barrier device.

25. The safety apparatus according to claim 24, wherein the light source device is configured for generating the safety light field in a form of a beam tube which extends along the at least one longitudinal axis and radially surrounds the light path of the laser beam on at least a half-side.

26. The safety apparatus according to claim 25, wherein the light source device is configured for generating the safety light field in the form of the beam tube which radially surrounds the light path of the laser beam on all sides.

27. The safety apparatus according to claim 25, wherein the beam tube has a shape of a straight circular cylinder or a cone shape.

28. The safety apparatus according to claim 24, wherein the safety light field has a cross-sectional shape which, in relation to the light path of the laser beam, extends radially over at least one angular section of less than 180°.

29. The safety apparatus according to claim 24, wherein the light source device comprises one single light source with a divergent beam field and a beam shaping device arranged to shape the safety light field from the divergent beam field.

30. The safety apparatus according to claim 29, wherein:
the beam shaping device comprises a mirror arrangement with a deflection mirror and a collimating mirror, and
the light source is arranged radially spaced from the at least one longitudinal axis, wherein
the deflection mirror is arranged for deflecting the divergent beam field of the light source towards the at least one longitudinal axis and the collimation mirror is arranged for shaping the safety light field parallel or divergent relative to the at least one longitudinal axis.

31. The safety apparatus according to claim 24, wherein the light source device comprises a plurality of light sources arranged for shaping the safety light field.

32. The safety apparatus according to claim 24, wherein the sensor device comprises a light-sensitive sensor area adapted to a cross-sectional shape of the safety light field.

33. The safety apparatus according to claim 32, wherein the light-sensitive sensor area of the sensor device has a shape of a half circular ring.

34. The safety apparatus according to claim 32, wherein the light-sensitive sensor area of the sensor device has a shape of a complete circular ring.

35. The safety apparatus according to claim 24, wherein the at least one sensor element comprises a photoresistor or a photodiode.

36. The safety apparatus according to claim 24, wherein the at least one sensor element is provided with a beam collector which is configured for collecting the safety light field at the at least one sensor element.

37. The safety apparatus according to claim 24, wherein the sensor device comprises a plurality of sensor elements connected in series.

38. The safety apparatus according to claim 24, wherein the sensor device comprises a stray light shield which extends at an end portion of the safety light field on the sensor device along the at least one longitudinal axis and is arranged for shielding the safety light field from ambient light.

39. The safety apparatus according to claim 24, wherein:
the interrupter device comprises a beam blocker and a drive device coupled to the sensor device, wherein
the beam blocker is movable with the drive device into or out of the light path of the laser beam in dependency on the sensor signal of the sensor device.

40. The safety apparatus according to claim 39, wherein the beam blocker has at least one of the features:
the beam blocker comprises a synthetic foam material,
the beam blocker comprises a clear, non-absorbent translucent plastic, and
the beam blocker comprises PTFE.

41. The safety apparatus according to claim 39, wherein the beam blocker has a shape of a hollow cylinder which is pivotable about a transverse axis perpendicular to the at least one longitudinal axis such that the beam blocker clears the light path of the laser beam in a non-pivoted state and blocks the light path of the laser beam in a pivoted state.

42. The safety apparatus according to claim 39, wherein the beam blocker comprises a shutter contained in a laser source device for generating the laser beam.

43. The safety apparatus according to claim 24, wherein the at least one light barrier device and the interrupter device comprise axially extending passage openings which leave the light path of the laser beam free.

44. The safety apparatus according to claim 24, wherein the light source device, a ring mirror and the sensor device are arranged such that the safety light field extends from the light source device via the ring mirror to the sensor device.

45. The safety apparatus according to claim 24, wherein:
the light source device is configured for a modulated operation such that a modulation is applied on the safety light field, and
the sensor device is coupled to an evaluation device which configured for detecting the modulation of the safety light field and for generating the sensor signal only when the modulation of the safety light field is detected.

46. The safety apparatus according to claim 24, wherein one single light barrier device is provided, wherein the light source device and the sensor device are arranged at the ends of a light path of the laser beam to be monitored.

47. The safety apparatus according to claim 24, wherein:
at least two light barrier devices are provided, which are arranged consecutively to one another on the light path of the laser beam to be monitored, wherein the light source device and the sensor device of each of the at least two light barrier devices are arranged at ends of a respective section of the safety light field of the light path of the laser beam to be monitored, wherein
the interrupter device is coupled to each light barrier device and is arranged for interrupting the laser beam dependent on a change in the sensor signal from at least one of the light barrier devices.

48. A laser apparatus, comprising:
a laser source device configured for generating a laser beam along a light path, and
the safety apparatus according to claim 24, which is arranged for monitoring the light path of the laser beam and for interrupting the laser beam in response to an approach of an object to the laser beam.

49. The laser apparatus according to claim 48, wherein the light source device of the at least one light barrier device and the interrupter device are part of the laser source device and/or are fixedly coupled thereto.

50. A method of using the safety apparatus according to claim 24, including a step of securing an operating area between at least one laser source device and a fusion reactor.

51. A method for monitoring a light path of a laser beam and for interrupting the laser beam in response to an approach of an object to the laser beam, wherein the safety apparatus according to claim 24 is used, comprising the steps of:
generating the at least one safety light field and detecting the at least one sensor signal of the at least one light barrier device, which corresponds to an undisturbed safety light field, and
actuating of the interrupter device in the event of a change in the at least one sensor signal as a result of at least partial coverage of the at least one safety light field by the object, so that the laser beam is interrupted.
